(19) United States
(12) Patent Application Publication
(10) Pub. No.: US 2007/0263392 A1
(43) Pub. Date: Nov. 15, 2007

(54) Collapsible lampshade

(76) Inventor: Duan-Cheng Hsieh, Taipei City (TW)

Correspondence Address: TROP PRUNER & HU, PC, 1616 S. VOSS ROAD, SUITE 750, HOUSTON, TX, 77057-2631, US

(21) Appl. No.: 11/431,333

(22) Filed: May 10, 2006

(51) Int. Cl. F21V 1/06

(52) U.S. Cl. 362/352

(57) ABSTRACT

A collapsible lampshade includes: upper and lower frames; a flexible cover sheet interconnecting the upper and lower frames; and a plurality of ribs, each of which is pivoted to the lower frame and each of which is detachably connected to the upper frame.

### BACKGROUND OF THE INVENTION

1. Field of the Invention

The invention relates to a lampshade, more particularly to a collapsible lampshade.

2. Description of the Related Art

As shown in FIG. 1, a conventional lampshade 1 includes a cover sheet 11, an upper frame 12 mounted on a top end of the cover sheet 11, a lower frame 13 mounted on a bottom end of the cover sheet 11, and a plurality of ribs 14 welded to and interconnecting the upper and lower frames 12, 13. Since the upper and lower frames 12, 13 and the ribs 14 are welded together, the lampshade 1 cannot be folded. As such, the lampshade 1 requires a relatively large space for packaging and transport.

Another conventional lampshade includes detachable ribs that are detachably connected to the upper and lower frames. However, disassembly or re-assembly of the lampshade is laborious.

### SUMMARY OF THE INVENTION

Therefore, the object of the present invention is to provide a collapsible lampshade that can overcome the aforesaid drawbacks associated with the prior art.

Accordingly, a collapsible lampshade of this invention comprises: upper and lower frames; a flexible cover sheet interconnecting the upper and lower frames; a plurality of ribs, each of which is pivoted to the lower frame and each of which is detachably connected to the upper frame.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled perspective view of a conventional lampshade;

FIG. 2 is an assembled perspective view of the preferred embodiment of a collapsible lampshade according to the present invention;

FIG. 3 is a schematic top view of the preferred embodiment;

FIG. 4 is a schematic side view of the preferred embodiment;

FIG. 5 is a schematic bottom view of an upper frame of the preferred embodiment;

FIG. 6 is a sectional view taken along line VI-VI in FIG. 5;

FIG. 7 is a schematic view of a rib of the preferred embodiment;

FIG. 8 is a sectional view taken along line VIII-VIII in FIG. 3;

FIG. 9 is an assembled perspective view of the preferred embodiment disposed at a collapsed state; and

FIG. 10 is a schematic bottom view of the preferred embodiment disposed at the collapsed state.

### DETAILED DESCRIPTION OF THE PREFERRED EMBODIMENT

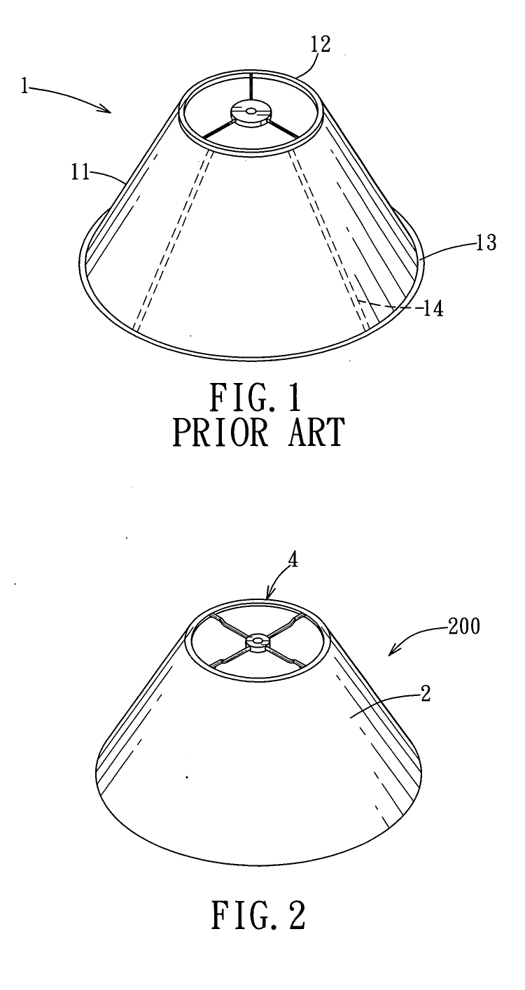

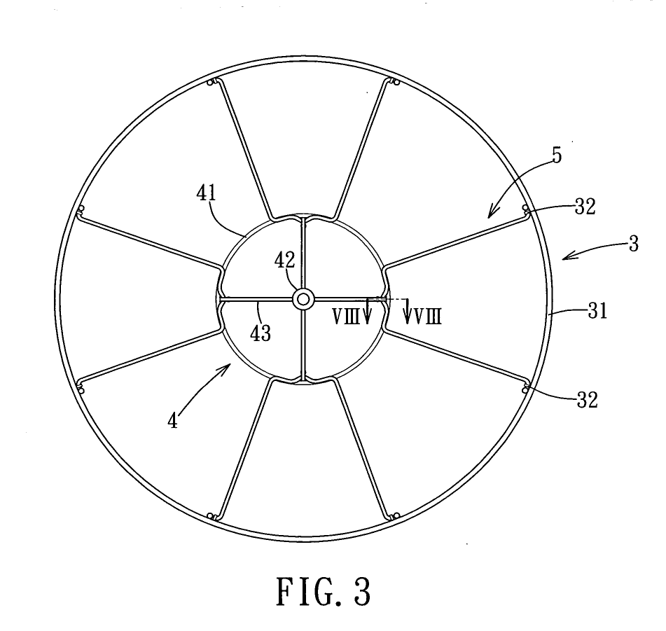

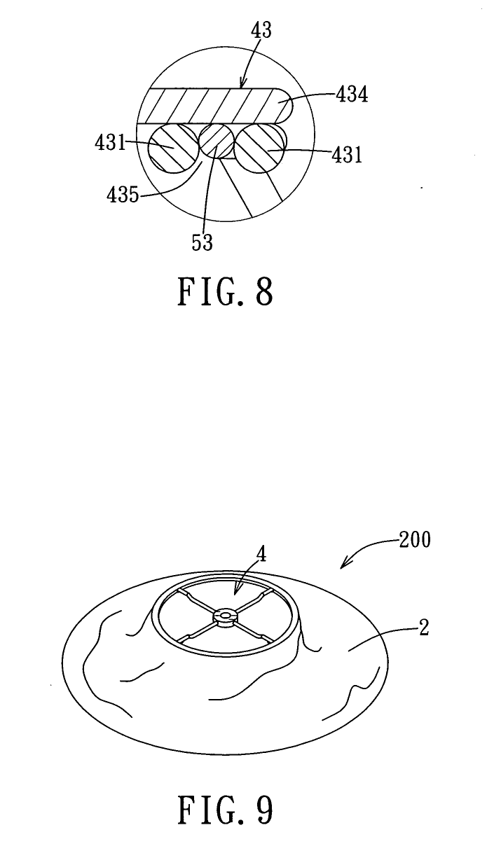

Referring to FIGS. 2 to 8, the preferred embodiment of a collapsible lampshade 200 according to the present invention is shown to include: upper and lower frames 3, 4; a flexible cover sheet 2 interconnecting the upper and lower frames 3, 4; and a plurality of ribs 5, each of which is pivoted to the lower frame 3 and each of which is detachably connected to the upper frame 4. In this embodiment, the upper and lower frames 3, 4 and the ribs 5 are made from metal. The cover sheet 2 is made from a soft flexible material.

The lower frame 3 includes a lower ring 31 mounted to a bottom end of the cover sheet 2, and four engaging loops 32 that are secured to an inner surface of the lower ring 31. Two adjacent ones of the engaging loops 32 are angularly spaced apart by 90 degrees.

Referring to FIGS. 3, 5, and 6, the upper frame 4 is formed with a plurality of retaining units 432, each of which defines a retaining groove 435. Referring to FIG. 7, each of the ribs 5 is in the form of an inverted U-shaped rod, and has a bent tip portion 53 that is in snap engagement with a respective one of the retaining units 432 when snapped into the retaining groove 435 of the respective one of the retaining units 432. Moreover, each of the ribs 5 has two opposite ends 54 connected pivotally to two adjacent ones of the engaging loops 32 on the lower ring 31. Each of the ribs 5 is formed with a pair of limiting protrusions 541 protruding respectively from the ends 54 of the rib 5 and abutting against the respective engaging loops 32 so as to prevent removal of the ribs 5 from the lower frame 3.

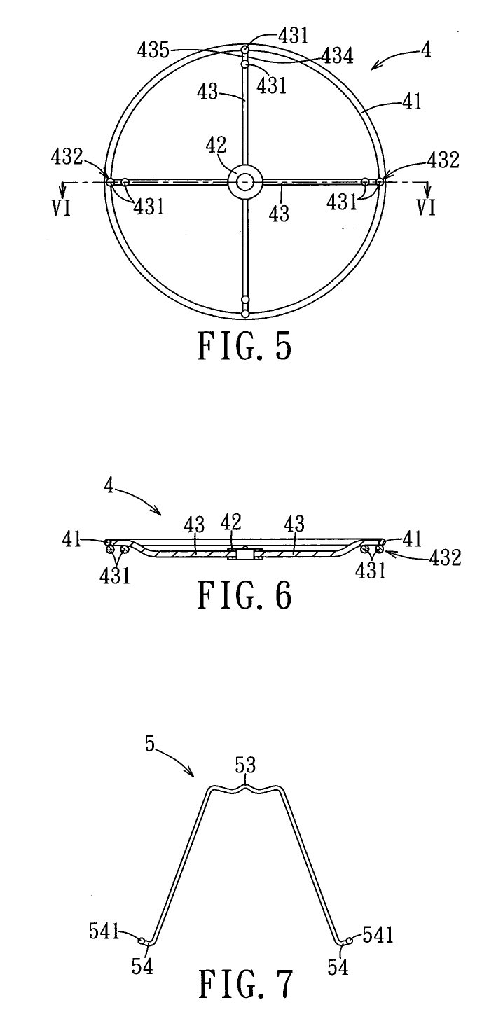

Referring again to FIG. 5, the upper frame 4 includes inner and outer rings 42, 41, and a plurality of struts 43 interconnecting the inner and outer rings 42, 41. Each of the struts 43 has an inner end 433 connected to the inner ring 42, and an outer end 434 connected to the outer ring 41 and formed with a respective one of the retaining units 432. In this embodiment, two adjacent ones of the struts 43 are angularly spaced apart by 90 degrees.

Each of the retaining units 432 includes inner and outer spherical protrusions 431 that protrude from the outer end 434 of a respective one of the struts 43 and that cooperatively define the retaining groove 435. In this embodiment, the outer spherical protrusion 431 of each of the retaining units 432 is welded to the outer ring 41. The inner and outer ends 433, 434 of each strut 43 are respectively welded to the inner and outer rings 42.

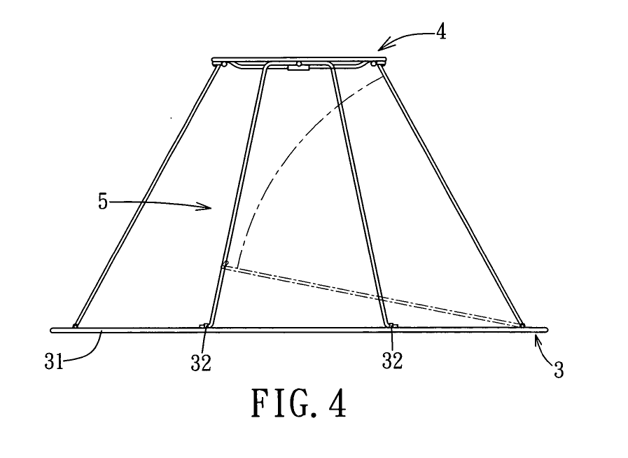

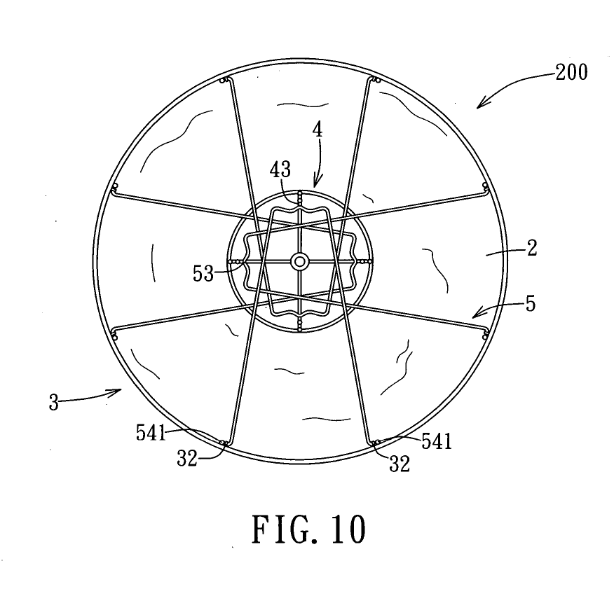

To assemble the lampshade 200, the top and bottom ends of the cover sheet 2 are respectively mounted to the outer ring 41 of the upper frame 4 and the lower ring 31 of the lower frame 3. The ends 54 of each of the ribs 5 are then extended through the respective engaging loops 32, and are retained on the lower ring 31 by the limiting protrusions 541. The bent tip portions 53 of the ribs 5 are subsequently snapped into the retaining grooves 435 in the retaining units 432 of the upper frame 4, respectively, to complete the assembly operation. When it is desired to fold the lampshade 200 for transport or storage purposes, the bent tip portion 53 of each of the ribs 5 can be easily pulled out of the retaining groove 435 in the respective retaining unit 432 so as to permit each rib 5 to rotate relative to the lower ring 31 to a lower position (see FIGS. 4, 9 and 10), which, in turn, results in collapsing of the lampshade 200.

With the inclusion of the retaining units 432 and the inverted U-shaped ribs 5 in the lampshade 200 of this invention, the aforesaid drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A collapsible lampshade comprising:
upper and lower frames;
a flexible cover sheet interconnecting said upper and lower frames; and
a plurality of ribs, each of which is pivoted to said lower frame and each of which is detachably connected to said upper frame.

2. The collapsible lampshade as claimed in claim 1, wherein said upper frame is formed with a plurality of retaining units, each of which defines a retaining groove, each of said ribs being in the form of an inverted U-shaped rod and having a bent tip portion that is in snap engagement with a respective one of said retaining units when snapped into said retaining groove of the respective one of said retaining units.

3. The collapsible lampshade as claimed in claim 2, wherein each of said ribs has two opposite ends pivoted to said lower frame.

4. The collapsible lampshade as claimed in claim 3, wherein said upper frame includes inner and outer rings, and a plurality of struts interconnecting said inner and outer rings, each of said struts having an outer end connected to said outer ring and formed with a respective one of said retaining units.

5. The collapsible lampshade as claimed in claim 4, wherein each of said retaining units includes inner and outer spherical protrusions that protrude from said outer end of a respective one of said struts and that cooperatively define said retaining groove.

6. The collapsible lampshade as claimed in claim 5, wherein said outer spherical protrusion of each of said retaining units is welded to said upper frame.
